(19) United States
(12) Patent Application Publication
(10) Pub. No.: US 2026/0339101 A1
(43) Pub. Date: Oct. 29, 2026

(54) REFLECTIVE FACET WAVEGUIDE WITH LAMINATED FACET LAYERS

(71) Applicant: GOOGLE LLC, Mountain View, CA (US)

(72) Inventors: Daniel Adema, Kitchener (CA); Timothy Paul Bodiya, Toronto (CA)

(21) Appl. No.: 19/120,622

(22) PCT Filed: Oct. 11, 2023
(86) PCT No.: PCT/US2023/076547

§ 371 Date: Apr. 11, 2025

(51) Int. Cl. G02B 27/01; G02B 6/34

(52) U.S. Cl. CPC G02B 27/0172; G02B 6/34

(57) ABSTRACT

To prevent a ghost image from being projected to a retina. SOLUTION: An image projection device comprises: a scan unit two-dimensionally scanning a light beam emitted from a light source; a projection mirror having a plurality of laminated layers through which the scanned light beam passes and which include at least two layers with different refraction index from each other, and making the scanned light beam reflect on a retina in an eyeball to project an image onto the retina; and a polarization part for polarizing the light beam emitted from the light source so that a light beam of P-polarized light is almost made incident on the projection mirror.

### BACKGROUND

In an eyewear display, display light beams from a light engine are initially coupled into a waveguide by an incoupler which can be formed on a surface, or multiple surfaces, of the waveguide or disposed within the waveguide. Once the display light beams have been coupled into the waveguide, the incoupled display light beams are “guided” through the waveguide, typically by multiple instances of total internal reflection (TIR), to then be directed out of the waveguide by an outcoupler, which can also be formed on or within the waveguide. The outcoupled display light beams overlap at an eye relief distance from the waveguide forming an exit pupil within which a virtual image generated by the light engine can be viewed by the user of the eyewear display. The waveguide can also include an exit pupil expander positioned between the incoupler and the outcoupler to increase the size of the exit pupil within which the user can view the virtual image.

In some cases, one or more of the incoupler, exit pupil expander, and the outcoupler are implemented in the waveguide as a set of reflective facets. Conventional waveguides with reflective facets are often susceptible to diminished optical performance due to discontinuities in the virtual image delivered to the user.

### SUMMARY

Various embodiments include a waveguide with overlapping sets of reflective facets that reduce or eliminate discontinuities in light that is outcoupled by the waveguide.

In a first embodiment, a waveguide includes a plurality of reflective faces sets. Each reflective facet set of the plurality of reflective facet sets includes a first reflective facet to reflect light having a first optical characteristic and a second reflective facet to reflect light having a second optical characteristic that is different from the first optical characteristic. The first reflective facet in a first reflective facet set of the plurality of reflective facet sets overlaps a first reflective facet of a second set of the plurality of reflective facet sets.

In some aspects of the first embodiment, a second reflective facet of the first reflective facet set overlaps a second reflective facet of the second reflective facet set. In some aspects, the first optical characteristic is a first wavelength range, and the second optical characteristic is a second wavelength range. For example, in some cases, the first wavelength range corresponds to blue light, and the second wavelength range corresponds to red light. In some aspects, a third reflective facet of the first reflective facet set overlaps a third reflective facet of the second reflective facet set. The third reflective facet in each corresponding reflective facet set reflects light having a third optical characteristic that is different from the first optical characteristic and the second optical characteristic. For example, the third optical characteristic is a third wavelength range. In some cases, the first wavelength range corresponds to blue light, the second wavelength range corresponds to green light, and the third wavelength range corresponds to red light.

In some aspects of the first embodiment, the first optical characteristic is a first polarization state, and the second optical characteristic is a second polarization state.

In some aspects of the first embodiment, the first reflective facet in each reflective facet set transmits light having the second optical characteristic.

In some aspects of the first embodiment, the plurality of reflective facet sets is included in an outcoupler in the waveguide. In some aspects, the plurality of reflective facet sets is additionally or alternatively included in an incoupler or in an exit pupil expander in the waveguide.

In a second embodiment, a waveguide includes a first reflective facet set and a second reflective facet set. Each reflective facet of the first reflective facet set is configured to reflect light having a particular wavelength range different than other reflective facets in the first reflective facet set, and each reflective facet of the second reflective facet set is configured to reflect light having a particular wavelength range different than other reflective facets in the second reflective facet set. Reflective facets in the first reflective facet set and in the second reflective facet set that reflect a similar wavelength range overlap with one another in a direction of reflection.

In some aspects of the second embodiment, the first reflective facet set includes a first reflective facet that reflects light in a first wavelength range, a second reflective facet that reflects light in a second wavelength range, and a third reflective facet that reflects light in a third wavelength range. In some aspects, the first reflective facet transmits light in the second wavelength range and in the third wavelength range, and the second reflective facet transmits light in the third wavelength range. In some aspects, the second reflective facet set similarly includes a first reflective facet that reflects light in the first wavelength range, a second reflective facet that reflects light in the second wavelength range, and a third reflective facet that reflects light in the third wavelength range. In some aspects, each reflective facet in a corresponding reflective facet set is separated from other reflective facets in the corresponding reflective facet set by a carrier layer. In some aspects, the first reflective facet set is separated from the second reflective facet set by a spacer layer. For example, the spacer layer, in some cases, is thicker than the carrier layer separating the reflective facets of a corresponding reflective facet set. In some cases, the first reflective facet set, and the second reflective facet set are included in an outcoupler in the waveguide.

In a third embodiment, a method to outcouple light of a waveguide includes outcoupling light having a first wavelength range via a first reflective facet in a first reflective facet set and outcoupling light having a second wavelength range via a second reflective facet in the first reflective facet set, and outcoupling light having the first wavelength range via a first reflective facet in a second reflective facet set and outcoupling light having the second wavelength range via a second reflective facet in the second reflective facet set. In some cases, the first reflective facet in the first reflective facet set overlaps with the first reflective facet in the second reflective facet set in an outcoupling direction and the second reflective facet in the first reflective facet set overlaps with the second reflective facet in the second reflective facet set in the outcoupling direction.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display in accordance with some embodiments.

FIG. 2 shows an example of a projection system with a light filter arranged between the light engine and an incoupler of a waveguide of an eyewear display, such as that shown in FIG. 1, in accordance with some embodiments.

FIG. 3 shows a plan view illustrating an example of the propagation of light within the waveguide of the projection system of FIG. 2, in accordance with some embodiments.

FIG. 4 shows an example of a conventional reflective facet configuration and problems associated with such a configuration.

FIG. 5 shows a cross section view of components of a stack that is used to make a set of reflective facets in a waveguide, in accordance with some embodiments.

FIG. 6 shows a cross section view of the components of the stack shown in FIG. 5 together, in accordance with various embodiments.

FIG. 7 shows a cross section view of a final laminate stack including multiple laminated stacks shown in FIG. 6 in accordance with some embodiments.

FIG. 8 shows a cross section view of cuts made to the final laminate stack of FIG. 7 in accordance with some embodiments.

FIG. 9 shows an optical component segment with a plurality of reflective facet sets resulting from the cuts made as shown in FIG. 8 in accordance with some embodiments.

FIGS. 10 and 11 show examples of surface treatments made to the optical component segment of FIG. 9 in accordance with some embodiments.

FIGS. 12 and 13 show examples of integrating an optical component segment such as those shown in FIGS. 9-11 into a final waveguide, such as the waveguides shown in FIGS. 2 and 3, in accordance with some embodiments.

FIG. 14 shows a flowchart describing a method for outcoupling light via an outcoupler with overlapping sets of reflective facets in accordance with some embodiments.

### DETAILED DESCRIPTION

A reflective facet waveguide includes one or more sets of reflective facets to implement one or more of the incoupler, outcoupler, or exit pupil expander. Utilizing an outcoupler as an example, the outcoupler is realized as a set of reflective facets that receives light from the exit pupil expander and reflects the light out of the waveguide to the user. Typically, the set of reflective facets is made by applying a reflective coating to a series of planar faces on a molded plastic or polymer substrate. Ideally, each reflective facet has sharp corners at both edges and there is no gap between adjacent reflective facets. However, in reality, conventional molded plastic substrates have planar faces with rounded edges as well as draft angles (i.e., non-perpendicular angles) between the planar faces due to molding process limitations. These rounded edges and draft angles result in gaps between adjacent conventional reflective facets that are applied to the planar faces. The gaps between adjacent conventional reflective facets generate gaps in the outcoupled light, which in turn produce discontinuities in the virtual image delivered to the user. For example, if the virtual image is supposed to be a straight line, the gaps in the outcoupled light produce “blips” in the line that is perceived by the user. Described herein are waveguides with overlapping, laminated reflective facets that eliminate discontinuities in the light that is outcoupled by the waveguide, thereby improving the optical performance of the waveguide and of the eyewear display.

To illustrate, in some embodiments, a waveguide includes an incoupler, an exit pupil expander, and an outcoupler. At least one of these waveguide components, such as the outcoupler, is embodied in the waveguide as a plurality of reflective facet sets. Each reflective facet set of the plurality of reflective facet sets has a number of reflective facets, and each reflective facet reflects light having a particular optical characteristic in an outcoupling direction. For example, in some embodiments, each reflective facet set has a first reflective facet that reflects blue light in the outcoupling direction, a second reflective facet set that reflects green light in the outcoupling direction, and a third reflective facet that reflects red light in the outcoupling direction. Furthermore, in some embodiments, the first reflective facet transmits green and red light, the second reflective facet transmits red light and blue light, and the third reflective facet transmits green and blue light. Additionally, the first, second, and third reflective facets in each reflective facet set overlap with a corresponding first, second, and third reflective facet of an adjacent reflective facet set. In this manner, the overlapping sets of reflective facets eliminate gaps in the light that is outcoupled from the waveguide, thereby improving the quality of the image perceived by the user.

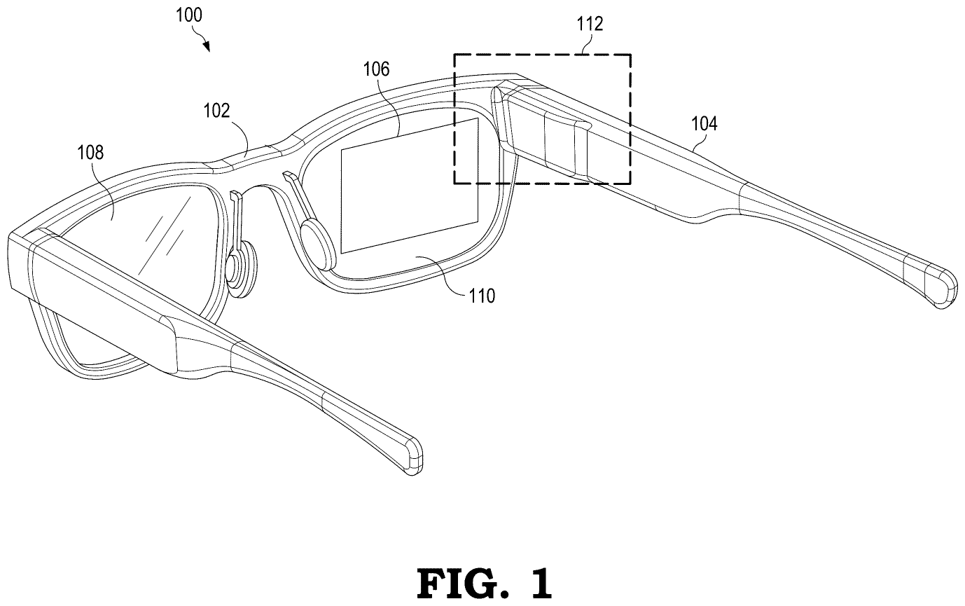

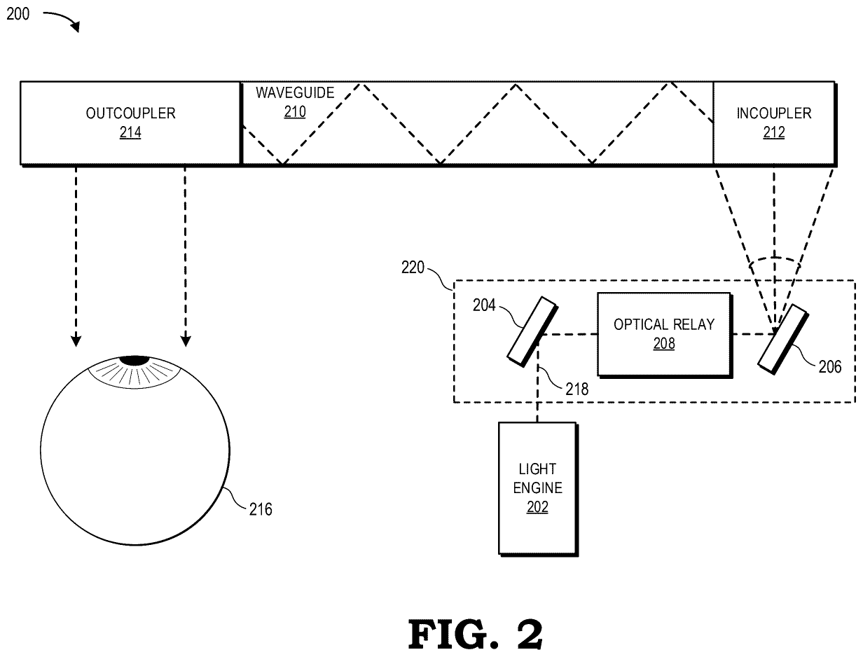

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as a light engine and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an augmented reality (AR) or mixed reality (MR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from a light engine in the eyewear display 100. For example, light used to form a perceptible image or series of images may be projected by the light engine of the eyewear display 100 onto the eye of the user via a series of optical elements, such as a waveguide formed at least partially in the corresponding lens element, one or more scan mirrors, one or more optical relays, and/or one or more prisms. One or both of the lens elements 108, 110 thus includes at least a portion of a waveguide that routes display light received by the incoupler of the waveguide to an outcoupler of the waveguide, which outputs the display light toward an eye of a user of the eyewear display 100. The display light is modulated and projected onto the eye of the user such that the user perceives the display light as an image in FOV area 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the light engine is a matrix-based projector, a scanning laser projector, or any combination of a modulative light source such as a laser or one or more LEDs and a dynamic reflector mechanism such as one or more dynamic scanners or digital light processors. In some embodiments, the light engine includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The light engine is communicatively coupled to a controller and a non-transitory processor-readable storage medium or memory storing processor-executable instructions and other data that, when executed by the controller, cause the controller to control the operation of the projector. In some embodiments, the controller controls a scan area size and scan area location for the light engine and is communicatively coupled to a processor (not shown) that generates content to be displayed at the eyewear display 100. The light engine scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the eyewear display 100.

As previously mentioned, a waveguide is integrated into one or both of lens elements 108, 110. In some configurations, the waveguide includes a single waveguide substrate and in other configurations, the waveguide includes multiple waveguide substrates stacked on top of one another (referred to as a waveguide stack). The waveguide, in some cases, includes one or more of an incoupler to incouple light from the light engine into the waveguide, an exit pupil expander to expand the incoupled light within the waveguide in one dimension, and an outcoupler to outcouple the display light to the eyebox of the eyewear display 100. In some cases, one or more of the incoupler, the exit pupil expander, and the outcoupler are implemented in the waveguide as a corresponding set of reflective facets. For example, the outcoupler is embodied as a plurality of reflective facet sets that receive light from the exit pupil expander and redirect the light out of the waveguide to the user via FOV area 106. In some embodiments, each reflective facet set of the plurality of reflective facet sets includes a first reflective facet that reflects light having a first optical characteristic (e.g., a first wavelength range) to an outcoupling direction corresponding to the FOV area 106 and a second reflective facet that reflects light having a second optical characteristic (e.g., a second wavelength range) to the outcoupling direction. The first reflective facet in each reflective facet set overlaps with the first reflective facet in the adjacent reflective facet set(s) and the second reflective in each reflective facet set overlaps with the second reflective facet in the adjacent reflective facet set(s). This minimizes or eliminates gaps in the light that is outcoupled via FOA area 106, thereby improving the optical performance of the eyewear display 100.

FIG. 2 illustrates a diagram of a projection system 200 that projects images onto the eye 216 of a user in accordance with various embodiments. The projection system 200, which may be implemented in the eyewear display 100 in FIG. 1, includes one or more of a light engine 202, an optical scanner 220, and/or a waveguide 210. In this example, the optical scanner 220 includes a first scan mirror 204, a second scan mirror 206, and an optical relay 208. The waveguide 210 includes one or more incouplers 212 and one or more outcouplers 214, with the one or more outcouplers 214 being optically aligned with an eye 216 of a user. For example, the one or more outcouplers 214 substantially overlaps with the FOV area 106 shown in FIG. 1.

The light engine 202 includes one or more light sources configured to generate and output light 218 (e.g., visible light such as red, blue, and green laser light and/or non-visible laser light such as infrared laser light). In some embodiments, the light engine 202 is coupled to a controller or driver (not shown), which controls the timing of emission of light from the light sources of the light engine 202 (e.g., in accordance with instructions received by the controller or driver from a computer processor coupled thereto) to modulate the light 218 to be perceived as images when output to the retina of the eye 216 of the user. For example, during operation of the projection system 200, one or more beams of display light 218 are output by the light source(s) of the light engine 202 and then directed into the waveguide 210 before being directed to the eye 216 of the user. The light engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, the optical scanner 220 includes a first scan mirror 204, a second scan mirror 206, and an optical relay 208. One or both of the scan mirrors 204 and 206 are MEMS mirrors, in some embodiments. For example, the scan mirror 204 and the scan mirror 206 are MEMS mirrors that are driven by respective actuation voltages to oscillate during active operation of the laser projection system 200, causing the scan mirrors 204 and 206 to scan the laser light 218. Oscillation of the scan mirror 204 causes light 218 output by the optical engine 202 to be scanned through the optical relay 208 and across a surface of the second scan mirror 206. The second scan mirror 206 scans the light 218 received from the scan mirror 204 toward an incoupler 212 of the waveguide 210.

The waveguide 210 of the projection system 200 includes an incoupler 212 and an outcoupler 214. The term “waveguide,” as used herein, will be understood to mean a combiner using total internal reflection (TIR), or via a combination of TIR, specialized filters, and/or reflective surfaces, to transfer light from an incoupler to an outcoupler. For display applications, the light is representative of a collimated image, for example, and the waveguide transfers and replicates the collimated image to the eye. In general, the terms “incoupler” and “outcoupler” will be understood to refer to any type of optical grating structure, including, but not limited to, a set of reflective facets, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, one or more of the incoupler 212, an exit pupil expander (not shown in FIG. 2), and the outcoupler 214 are implemented in the waveguide 210 by a plurality of reflective facet sets as described herein. In the present example, the light 218 received at the incoupler 212 is propagated to the outcoupler 214 via the waveguide 210 using TIR. The laser light 218 is then output to the eye 216 of a user via the outcoupler 214.

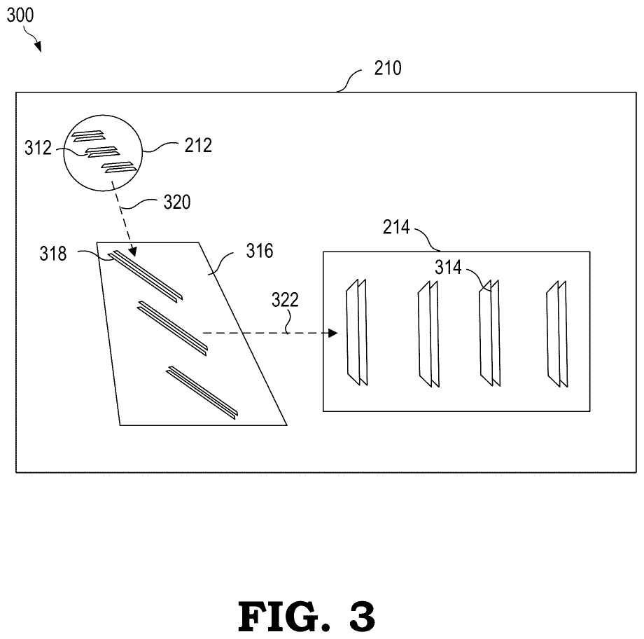

FIG. 3 shows a plan view of an example of light propagation within the waveguide 210 of the projection system 200 of FIG. 2. As shown, light is received via incoupler 212, directed as light 320 into an exit pupil expander (EPE) 316, and then routed as light 322 to the outcoupler 214 to be output from the waveguide 212 toward the eye of the user (e.g., the light is reflected by the outcoupler 214 in a direction out of the page). In some embodiments, the exit pupil expander 316 expands one or more dimensions of the eyebox of an eyewear display that includes the laser projection system 200 (e.g., with respect to what the dimensions of the eyebox of the eyewear display would be without the exit pupil expander 316). In some embodiments, at least one of the incoupler 212, the exit pupil expander 316, and the outcoupler 214 each include a plurality of reflective facet sets. For example, at the incoupler 212, a first plurality of reflective facet sets 312 (one labeled for clarity) receives light from emitted from the light engine (such as from light engine 202 in FIG. 2, not shown in FIG. 3) and reflects the light such that the light 320 is incoupled into the waveguide 210. A second plurality of reflective facet sets 318 (one labeled for clarity) at the exit pupil expander 316 receives the incoupled light 320 and reflects the light such that the light is expanded in a second direction 322 towards the outcoupler 214. A third plurality of reflective facet sets 314 (one labeled for clarity) at the outcoupler 214 reflects the light received from the exit pupil expander 316 such that the light is outcoupled of the waveguide 210, which in this illustration, corresponds to an outcoupling direction out of the page. As described further herein, in some embodiments, each reflective facet in the reflective facet sets (e.g., reflective facet set 314 in the outcoupler 214) reflects light having a particular optical characteristic, such as a particular wavelength range, and each reflective facet in the reflective facet sets overlaps with a reflective facet that reflects light with the same optical characteristic in an adjacent reflective facet set. This eliminates or reduces gaps in the light that is reflected from the respective optical component (e.g., from the outcoupler 214).

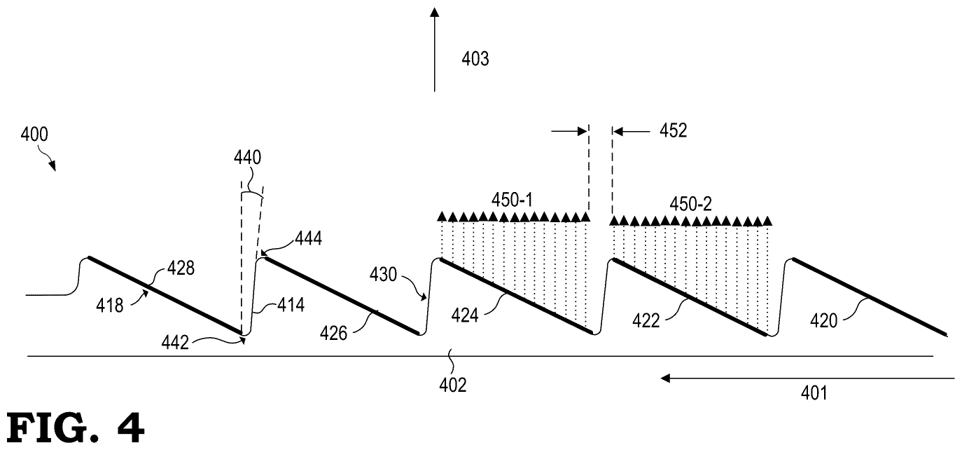

FIG. 4 shows a cross-section view 400 illustrating a set of conventional reflective facets 420-428 in a waveguide (not shown for clarity) and associated problems. When implemented in the waveguide as an outcoupler, for example, the set of conventional reflective facets 420-428 receives light from an exit pupil expander coming from a first direction indicated by arrow 401 and redirects the light out of the waveguide to the user in a second direction indicated by arrow 403.

Generally, the substrate 402 is manufactured by a molding process and is made of a plastic or polymer material that is at least partially transparent. The molded substrate 402 includes a plurality of planar faces 418 (one labeled for clarity). The molded substrate 402 also includes a plurality of secondary planar surfaces 430 (one labeled for clarity). The set of conventional reflective facets 420-428 is formed by applying a reflective coating to the plurality of planar faces 418. Ideally, the plurality of planar faces 418 of the substrate 402 have sharp corners and the secondary planar surfaces are vertical so that there are no gaps between adjacent ones of the reflective facets. In reality, the molded plastic substrates such as substrate 402 do not meet this ideal shape and instead include rounded tips 444 (one labeled for clarity) and rounded roots 442 (one labeled for clarity). In addition, the secondary planar surfaces 430 of molded plastic substrates such as substrate 402 are not vertical and impart draft angles 440 (one labeled for clarity) between the root 442 of one conventional reflective facet 428 and the tip 444 of an adjacent conventional reflective facet 426. The combination of the rounded edges (i.e., roots 442 and tips 442) and the draft angles 440 result in gaps between adjacent ones of the conventional reflective facets 420-428, which in turn create gaps in the light that is reflected by the set of conventional reflective facets 420-428. For example, referring to conventional reflective facets 422 and 424, there is a gap 452 between the light 450-1 reflected by conventional facet 424 and the light 450-2 reflected by conventional facet 422. These gaps 452 result in discontinuities in the virtual image that is delivered to the user, therefore resulting in diminished optical performance.

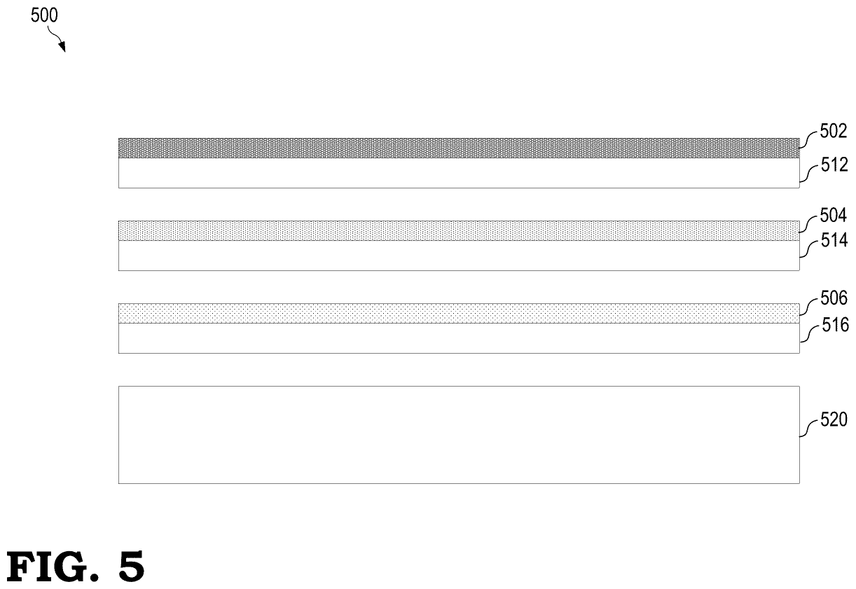

FIG. 5 shows a cross section view of components of a stack 500 in accordance with some embodiments. In some aspects, a stack such as stack 500 is used to make each reflective facet set of the plurality of reflective facet sets in a waveguide component (such as outcoupler 214 of FIGS. 2 and 3) of a waveguide (such as waveguide 210 of FIGS. 2 and 3) as described herein.

In some embodiments, the stack 500 includes reflective coating layers 502, 504, 506 and carrier film layers 512, 514, 516 as well as a spacer film layer 520. The reflective coating layers 502, 504, 506 (also referred to as reflective coatings) are dichroic coatings, dielectric coatings, metallic coatings, holographic coatings, or the like. The reflective coatings 502, 504, 506 are each configured to reflect light having a particular optical characteristic such as a particular wavelength range (i.e., color of light) or a particular polarization state. For example, the first reflective coating 502 is a dichroic mirror that reflects blue light. In some embodiments, the first reflective coating 502 also transmits green and red light. Furthermore, the second reflective coating 504 is a second dichroic mirror that reflects green light. In some embodiments, the second reflective coating 504 also transmits blue and red light. Additionally, the third reflective coating 506 is a third dichroic mirror that reflects red light. In some embodiments, the third reflective coating 506 also transmits blue and green light. In this manner, each one of the reflective coatings 502, 504, 506 is tuned or designed to reflect light having a particular optical characteristic (e.g., wavelength range) that is different from other ones of the reflective coatings 502, 504, 506 in the stack 500. The thickness of the reflective coatings 502, 504, 506 varies based on the manner in which the reflective coatings 502, 504, 506 are applied to the respective carrier film layers 512, 514, 516 (e.g., via lamination or other coating techniques). For example, in some embodiments, the thickness of the reflective coatings ranges from a few nanometers (e.g., less than 10 nanometers) up to about 10 microns.

The reflective coatings 503, 504, 506 are each respectively applied to one of the carrier film layers 512, 514, 516 (also referred to as carrier films for short). In some embodiments, the carrier films 512, 514, 516 are plastic or polymer film substrates that are mostly, if not completely, transparent. For example, in some cases, the material for the carrier films 512, 514, 516 is selected so that its refractive index matches that of the material selected for a waveguide substrate such as the substrate for waveguide 210 in FIGS. 2 and 3. In some configurations, the thickness of the carrier film layer 512, 514, 516 is the same, and in other configurations, the thickness of each of the carrier film layers 512, 514, 516 is different. The thickness of the carrier films 512, 514, 516 can range from about 50 microns to 200 microns. In some embodiments, the thickness of the carrier films 512, 514, 516 is designed to keep the separate color films (i.e., the reflective coatings) closer together.

In addition to the reflective coatings 502, 504, 506 and the carrier films 512, 514, 516, the stack 500, in some embodiments, also includes a spacer film layer 520 (also referred to as spacer film for short). In some cases, the spacer film 520 is made of the material selected for the carrier films 512, 514, 516. That is, the material of the spacer film 520 is selected so its refractive index matches that of the material selected for a waveguide substrate such as the substrate for waveguide 210 in FIGS. 2 and 3. In some embodiments, the thickness of the spacer film ranges from 50 microns to 200 microns.

Although shown as including three reflective coating layers in FIG. 5, in other embodiments, the stack 500 includes another number of reflective coatings (e.g., two or four) that are spaced apart in the manners described herein. For example, in some embodiments, the stack 500 includes two reflective coatings 502, 504, applied to respective carrier films 512, 514 instead of three reflective coatings 502, 504, 506 applied to respective carrier films 512, 514, 516 as shown in FIG. 5 (i.e., reflective coating 506 and carrier film 516 are omitted from the stack). Additionally, although described as being dichroic mirrors tuned to reflect and transmit different colors of light, in some embodiments, the reflective coatings 502, 504, 506 are holograms that are tuned to reflect and/or transmit light of different colors or polarization-selective mirrors that are tuned to reflect and/or transmit light having different polarization states (e.g., p-polarization, s-polarization, etc.).

In some embodiments, the particular configuration of the stack 500 (e.g., number of reflective coating layers and the thickness of the different layers in the stack 500) can be tuned depending on the optical component it is used for in the waveguide. For example, the configuration of the stack 500 is designed and tuned depending on whether the stack 500 will form a reflective facet set in the incoupler (such as the incoupler 212 of waveguide 210 of FIGS. 2 and 3), in the exit pupil expander (such as the exit pupil expander 316 of FIG. 3), or in the outcoupler (such as the outcoupler 214 of waveguide 210 of FIGS. 2 and 3).

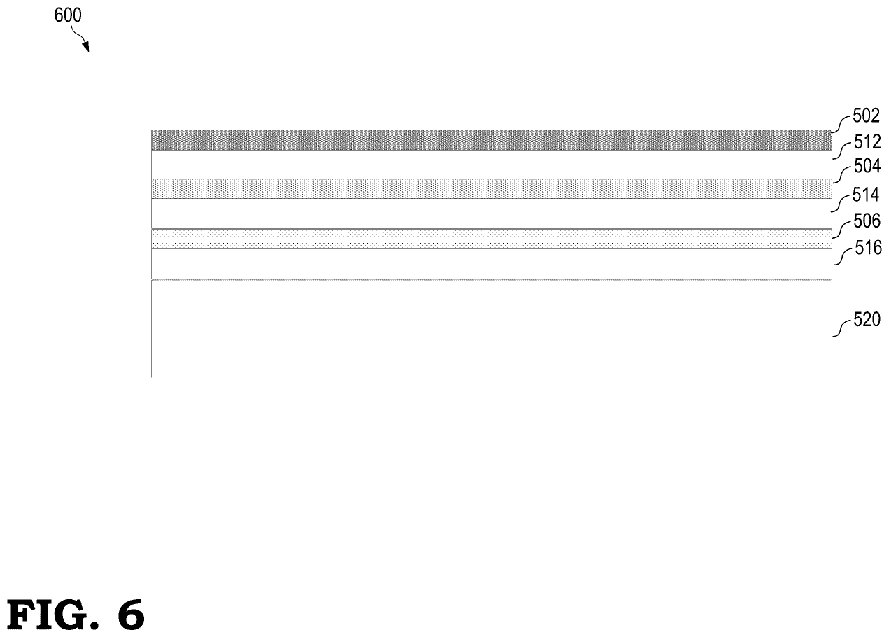

FIG. 6 shows a cross section view of a single laminate stack 600 (i.e., an assembled stack) corresponding to the stack 500 of FIG. 5 in accordance with some embodiments. As shown, the single laminate stack 600 includes the reflective coatings 502, 504, 516 that are each configured to reflect light having a particular optical characteristic such as a particular wavelength range of light. Additionally, the reflective coatings 502, 504, 516 are spaced apart from one another in the single laminate stack 600 by the carrier films 512, 514, 516. The single laminate stack 600 also includes the spacer film 520, which in this view, operates as a base of the laminate stack 600.

In this manner, the single laminate stack 600 includes a plurality (in this example, three) of reflective coatings that will form a set of reflective facets in the final waveguide structure as shown and described in later figures.

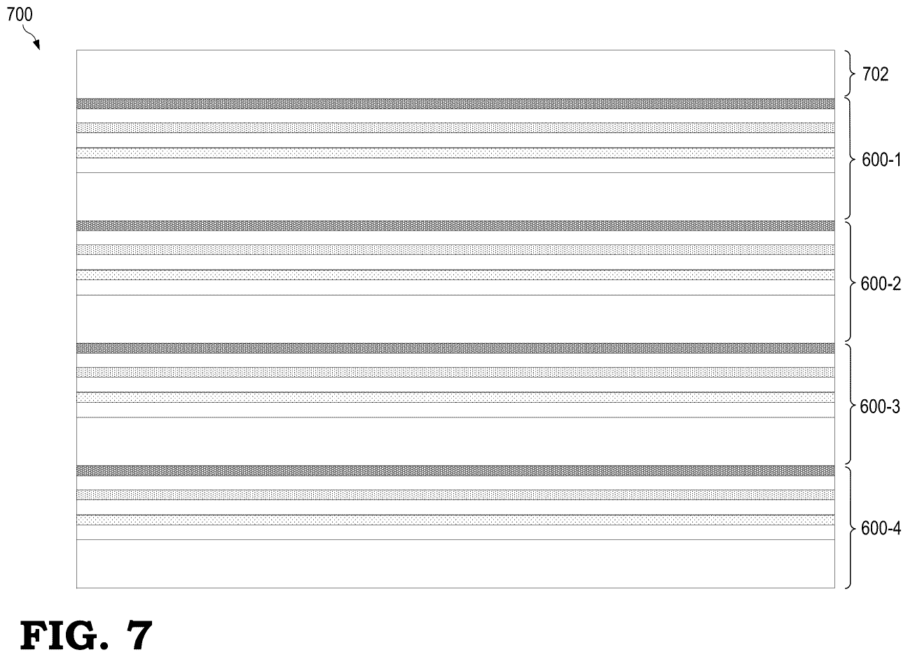

FIG. 7 shows a cross section view of final laminate stack 700 in accordance with some embodiments. The final laminate stack 700 includes multiple laminate stacks 600-1, 600-2, 600-3, 600-4 that each correspond to laminate stack 600 of FIG. 6. As shown, the final laminate stack 700 can also include a capping spacer film 702. In some aspects, the capping spacer film 702 is made of the same material as the spacer film 520. In some embodiments, the capping spacer film 702 has a thickness in the range from about 400 microns to about 2 millimeters. In some embodiments, the thickness of the capping spacer film 702 may be similar or the same as the thickness of the spacer film 520.

The final laminate stack 700 thus includes a plurality of laminate stacks 600-1, 600-2, 600-3, 600-4 and each one of the laminate stacks 600-1, 600-2, 600-3, 600-4 includes a plurality of reflective coatings as shown and described in FIG. 6 (not labeled in FIG. 7 for clarity purposes). In this manner, the final laminate stack 700 includes the components that form the plurality of reflective facet sets (e.g., each reflective facet set of the plurality of reflective facet sets corresponding to one of laminate stacks 600-1, 600-2, 600-3, 600-4), which in turn include the components that form the plurality of reflective facets (e.g., the plurality of reflective coatings in each one of laminate stacks 600-1, 600-2, 600-3, 600-4 as described in FIGS. 5 and 6). Although shown as including four laminate stacks 600-1, 600-2, 600-3, 600-4 in FIG. 7, in other embodiments, the final laminate stack 700 includes another number of laminate stacks 600 (i.e., other than four).

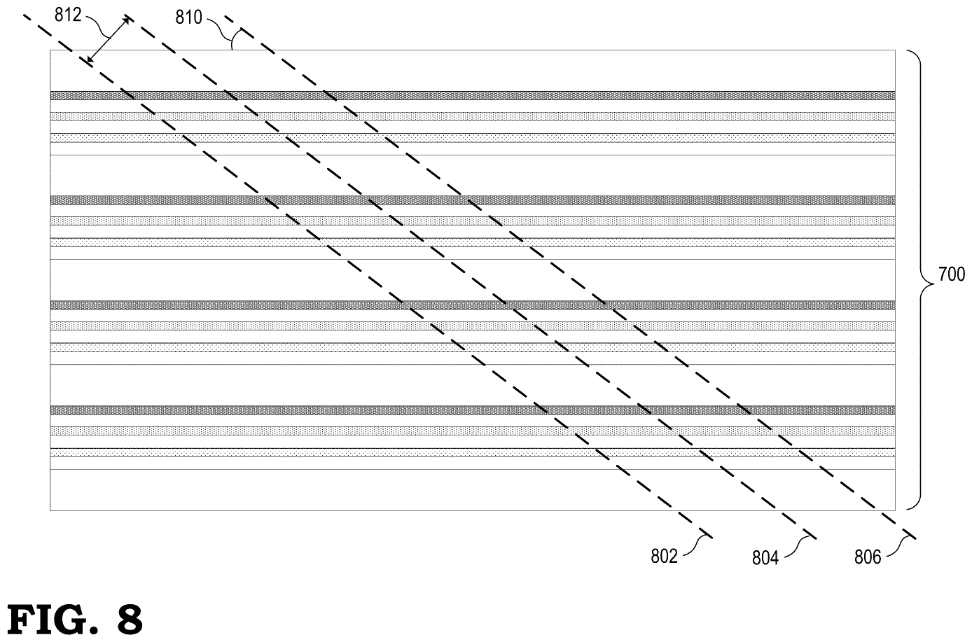

FIG. 8 shows a cross section view of cuts 802, 804, 806 made to the final laminate stack 700 of FIG. 7 in accordance with some embodiments. The cuts 802, 804, 806 are each made along a common cut angle 810 that ranges from 15° to 45° depending on the particular facet angle in the completed waveguide. For example, in some embodiments, the common cut angle 810 for the cuts 802, 804, 806 is about 30°. The length of the spacing 812 (only one labeled for clarity) between the cuts is selected based on the final dimensions of the reflective facets and the desired waveguide thickness. In some embodiments, the length of the spacing 812 ranges from 400 microns to 2 millimeters. In some aspects, the cuts 802, 804, 806 are made by mechanical techniques (e.g., with a saw blade or the like), laser cutting techniques, or a combination thereof.

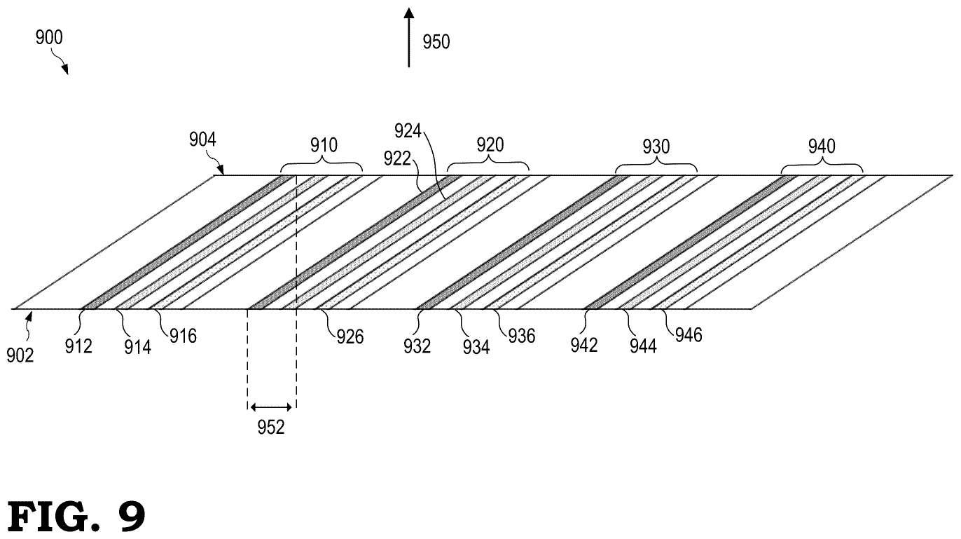

FIG. 9 shows an optical component segment 900 with a plurality of reflective facet sets resulting from the cuts made as shown in FIG. 8, in accordance with some embodiments. For example, as described in the later figures, the optical component segment 900 is included in one or more of the incoupler, exit pupil expander, or the outcoupler of a waveguide (e.g., such as waveguide 210 of FIGS. 2 and 3) in an eyewear display (e.g., such as eyewear display 100 of FIG. 1).

As shown, the optical component segment 900 includes two surfaces 902, 904 resulting from two cuts (e.g., cuts 802, 804, respectively, of FIG. 8) made to the final laminate stack 700. That is, the bottom surface 902 corresponds to a surface made by cut 802 of FIG. 8 and the top surface 904 corresponds to a surface made by cut 804 of FIG. 8. The optical component segment 900 also includes a plurality of reflective facet sets 910, 920, 930, 940. Each one of the plurality of reflective facet sets 910, 920, 930, 940 includes a plurality of reflective facets. For example, the first reflective facet 910 includes a first reflective facet 912, a second reflective facet 914, and a third reflective facet 916. Similarly, the second reflective facet set 920 includes a first reflective facet 922, a second reflective facet 924, and a third reflective facet 926, the third reflective facet set 930 includes a first reflective facet 932, a second reflective facet 934, and a third reflective facet 936, and the fourth reflective facet set 940 includes a first reflective facet 942, a second reflective facet 944, and a third reflective facet 946. Each one of the respective first, second, and third reflective facets in each of the reflective facets sets corresponds to a different respective one of the reflective coatings 502, 504, 506 described in FIG. 5. That is, referring to the first reflective facet set 910, the first reflective facet 912 reflects blue light, the second reflective facet 914 reflects green light, and the third reflective facet 916 reflects red light. Each one of the first, second, and third reflective facets in the other reflective facet sets 920, 930, 940 reflect light in a similar manner. The reflective facets in each reflective facet set 910, 920, 930, 940 have a spacing between other reflective facets in the reflective facet set and a facet angle based on the thickness of the different layers for the stacks and laminate stacks described in FIGS. 5-7 as well as the cut angle described in FIG. 8. In addition, the spacing between the reflective facet sets (e.g., between reflective facet set 910 and reflective facet set 920) is similarly set based on the thickness of the different layers for the stacks and laminate stacks described in FIGS. 5-7 as well as the cut angle described in FIG. 8.

In some embodiments, reflective facets that reflect light with a similar optical characteristic in adjacent reflective facet sets overlap with one another in the reflection direction indicated by arrow 950. For example, if the optical component segment 900 is implemented at an outcoupler, the reflection direction indicated by arrow 950 corresponds to the outcoupling direction. An example of an overlap 952 is shown with respect to the first reflective facet 912 in reflective facet set 910 and the first reflective facet 922 in reflective facet set 920. For example, referring back to previous examples, the first reflective facet 912 in reflective facet set 910 and the first reflective facet 922 in reflective facet set 920 correspond to the first reflective coating 502 which is a dichroic mirror that reflects blue light (and transmits green light and red light). As illustrated in FIG. 9, the optical component segment 900 also includes overlaps (not labeled for clarity purposes) between reflective facets in adjacent reflective facet sets (i.e., reflective facet sets 910, 920, 930, 940) that reflect light having a similar optical characteristic. In this manner, the light that is reflected by the optical component segment 900 is uniform and does not include gaps in the light reflected by conventional reflective facet waveguides such the gaps illustrated and described in FIG. 4.

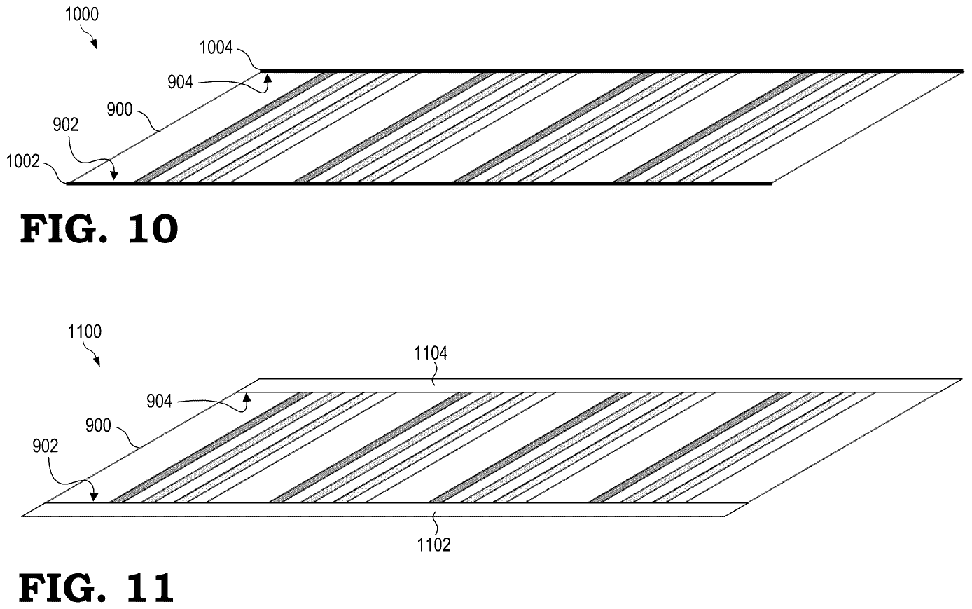

In some cases, depending on the cutting process used to perform the cuts 802, 804, 806 described in FIG. 8, the surfaces 902, 904 of the optical component segment 900 may require a surface treatment before integrating the optical component segment 900 into the final waveguide. Two examples of surface treatments are illustrated in FIGS. 10 and 11.

FIG. 10 shows an example of a first embodiment of a surface treatment 1000 applied to optical component segment 900 of FIG. 9 prior to integration into the final waveguide. Surface treatment 1000 includes applying coatings 1002, 1004 over surfaces 902, 904, respectively, of optical component segment 900. For example, the coatings 1002, 1004 are applied by spin coating, blade coating, slot coating, or other similar coating techniques. In some embodiments, the coatings 1002, 1004 are an anti-reflective coating or other type of optical coating with a particular optical characteristic (e.g., made from a material with a particular refractive index selected to pair with the refractive index of the substrate in the final waveguide). In some cases, the coatings 1002, 1004 improve the surface quality of the optical component segment 900 prior to integration into the final waveguide.

FIG. 11 shows an example of a second embodiment of a surface treatment 1100 applied to optical component segment 900 of FIG. 9 prior to integration into the final waveguide. Surface treatment 1100 includes laminating layers 1102, 1104 over surfaces 902, 904, respectively, of optical component segment 900. In some embodiments, the layers 1102, 1104 are an anti-reflective laminating layers or other type of optical layers having a particular optical characteristic (e.g., made from a material with a particular refractive index selected to pair with the refractive index of the substrate in the final waveguide). In some cases, the layers 1102, 1104 improve the surface quality of the optical component segment 900 prior to integration into the final waveguide.

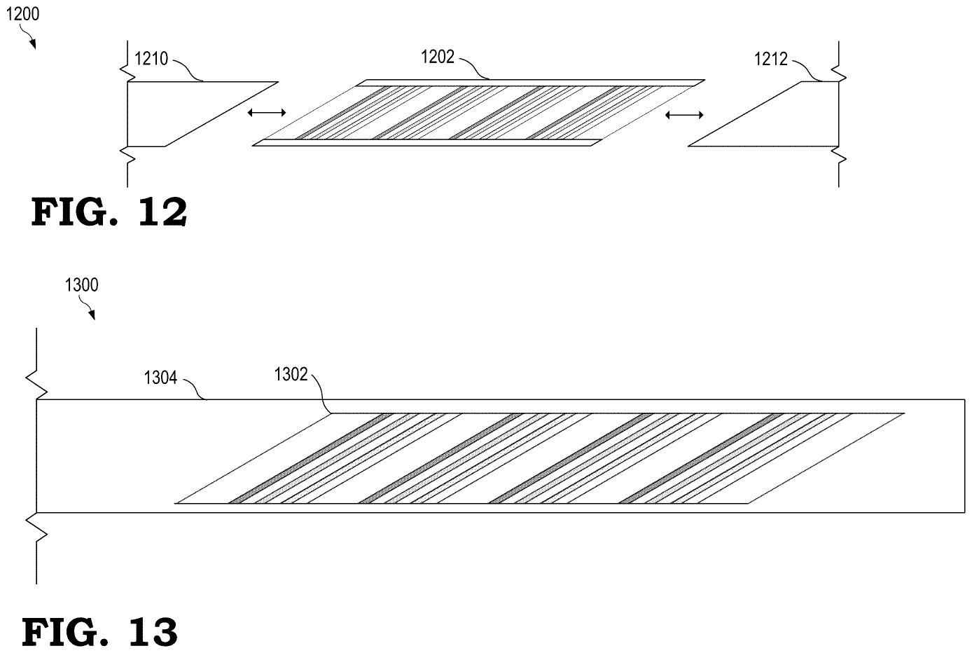

FIGS. 12 and 13 show examples of integrating an optical component segment (such as one corresponding to any one of optical component segment 900 of FIG. 9 or surface treated optical component segments 1000, 1100 of FIGS. 10 and 11) into a final waveguide.

In FIG. 12, the optical component segment 1202 is integrated into the final waveguide (such as one corresponding to waveguide 210 of FIGS. 2 and 3) by attaching the optical component segment 1202 to discrete components 1210, 1212 of the waveguide substrate. For example, if the optical component segment 1202 is integrated into the final waveguide as the outcoupler (such as outcoupler 214 of FIGS. 2 and 3), the optical component segment 1202 is assembled with discrete components 1210, 1212 that include the incoupler and exit pupil expander (not shown) as well as the rest of the waveguide substrate. In some embodiments, the optical component segment 1202 is attached to the discrete components 1210, 1212 of the waveguide substrate via an adhesive material with one or more particular optical properties (e.g., refractive index).

In FIG. 13, the optical component segment 1302 is integrated into the final waveguide (such as one corresponding to waveguide 210 of FIGS. 2 and 3) by overcasting or overmolding the optical component segment 1302 into the waveguide substrate 1304. For example, if the optical component segment 1302 is integrated into the final waveguide as the outcoupler (such as outcoupler 214 of FIGS. 2 and 3), the optical component segment 1302 is overcast into the waveguide substrate 1304 along with the incoupler and exit pupil expander (not shown). That is, the optical component segment 1302 is overcast into a waveguide substrate 1304 to form the final waveguide such as the waveguide 210 shown in FIGS. 2 and 3.

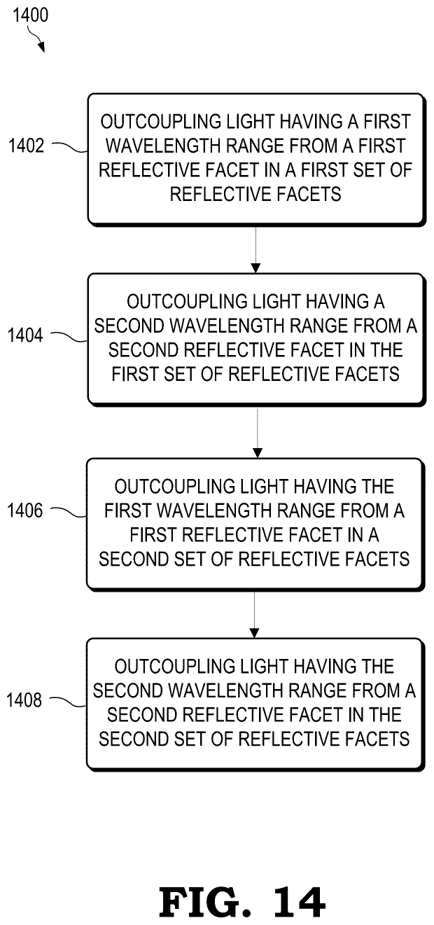

FIG. 14 shows a method flowchart 1400 for outcoupling light via an outcoupler with overlapping sets of reflective facets, such as those described with respect to FIGS. 9-13, in accordance with some embodiments.

At 1402, the method includes outcoupling light having a first wavelength range from a first reflective facet in a first set of reflective facets. At 1404, the method includes outcoupling light having a second wavelength range from a second reflective facet in the first set of reflective facets. At 1406, the method includes outcoupling light having the first wavelength range from a first reflective facet in a second set of reflective facets that overlaps with the first reflective facet in the first set of reflective facets in the outcoupling direction. At 1408, the method includes outcoupling light having the second wavelength range from a second reflective facet in the second set of reflective facets that overlaps with the second reflective facet in the first set of reflective facets in the outcoupling direction.

In some embodiments, the techniques provided herein eliminate the gaps between reflective facets as seen in conventional reflective facet waveguides. As such, the techniques described herein provide a waveguide with reflective facets that deliver a more uniform and higher quality virtual image to the user of an eyewear display such as that shown in FIG. 1.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
a plurality of reflective facet sets, wherein each reflective facet set of the plurality of reflective facet sets comprises a first reflective facet to reflect light having a first optical characteristic and a second reflective facet to reflect light having a second optical characteristic that is different from the first optical characteristic,
wherein a first reflective facet in a first reflective facet set of the plurality of reflective facet sets overlaps a first reflective facet of a second set of the plurality of reflective facet sets.

2. The waveguide of claim 1, wherein a second reflective facet of the first reflective facet set overlaps a second reflective facet of the second reflective facet set.

3. The waveguide of claim 2, wherein the first optical characteristic is a first wavelength range, and the second optical characteristic is a second wavelength range.

4. The waveguide of claim 3, wherein the first wavelength range corresponds to blue light, and the second wavelength range corresponds to red light.

5. The waveguide of claim 2, wherein a third reflective facet of the first reflective facet set overlaps a third reflective facet of the second reflective facet set, the third reflective facet in a corresponding reflective facet set to reflect light having a third optical characteristic that is different from the first optical characteristic and the second optical characteristic.

6. The waveguide of claim 5, wherein the first optical characteristic is a first wavelength range, the second optical characteristic is a second wavelength range, and the third optical characteristic is a third wavelength range.

7. The waveguide of claim 6, wherein the first wavelength range corresponds to blue light, the second wavelength range corresponds to green light, and the third wavelength range corresponds to red light.

8. The waveguide of claim 2, wherein the first optical characteristic is a first polarization state, and the second optical characteristic is a second polarization state.

9. The waveguide of claim 1, wherein the first reflective facet in each reflective facet set transmits light having the second optical characteristic.

10. The waveguide of claim 1, wherein the plurality of reflective facet sets is included in an outcoupler in the waveguide.

11. The waveguide of claim 1, wherein the plurality of reflective facet sets is included in an incoupler or in an exit pupil expander in the waveguide.

12. A waveguide comprising:
a first reflective facet set, each reflective facet of the first reflective facet set configured to reflect light having a particular wavelength range different than other reflective facets in the first reflective facet set; and
a second reflective facet set, each reflective facet of the second reflective facet set configured to reflect light having a particular wavelength range different than other reflective facets in the second reflective facet set,
wherein reflective facets in the first reflective facet set and in the second reflective facet set that reflect a similar wavelength range overlap with one another in a direction of reflection.

13. The waveguide of claim 12, wherein the first reflective facet set comprises a first reflective facet that reflects light in a first wavelength range, a second reflective facet that reflects light in a second wavelength range, and a third reflective facet that reflects light in a third wavelength range.

14. The waveguide of claim 13, wherein the first reflective facet transmits light in the second wavelength range and in the third wavelength range, wherein the second reflective facet transmits light in the third wavelength range.

15. The waveguide of claim 13, wherein the second reflective facet set comprises a first reflective facet that reflects light in the first wavelength range, a second reflective facet that reflects light in the second wavelength range, and a third reflective facet that reflects light in the third wavelength range.

16. The waveguide of claim 12, wherein each reflective facet in a corresponding reflective facet set is separated from other reflective facets in the corresponding reflective facet set by a carrier layer.

17. The waveguide of claim 16, wherein the first reflective facet set is separated from the second reflective facet set by a spacer layer.

18. The waveguide of claim 17, wherein the spacer layer is thicker than the carrier layer.

19. The waveguide of claim 12, wherein the first reflective facet set and the second reflective facet set are included in an outcoupler in the waveguide.

20. A method to outcouple light of a waveguide, the method comprising:
outcoupling light having a first wavelength range via a first reflective facet in a first reflective facet set and outcoupling light having a second wavelength range via a second reflective facet in the first reflective facet set; and
outcoupling light having the first wavelength range via a first reflective facet in a second reflective facet set and outcoupling light having the second wavelength range via a second reflective facet in the second reflective facet set,
wherein the first reflective facet in the first reflective facet set overlaps with the first reflective facet in the second reflective facet set in an outcoupling direction and the second reflective facet in the first reflective facet set overlaps with the second reflective facet in the second reflective facet set in the outcoupling direction.
